(19) United States
(12) Patent Application Publication
(10) Pub. No.: US 2021/0198138 A1
(43) Pub. Date: Jul. 1, 2021

(54) CDF-DREDGE, DROP-TUBE SEPARATOR AND METHOD OF TREATING WETLAND AREAS

(71) Applicant: Randall L. TUCKER, Findlay, OH (US)

(72) Inventor: Randall L. TUCKER, Findlay, OH (US)

(21) Appl. No.: 17/055,157

(22) PCT Filed: May 15, 2019
(86) PCT No.: PCT/US2019/032482

§ 371 Date: Nov. 13, 2020

Related U.S. Application Data
(60) Provisional application No. 62/671,656, filed on May 15, 2018.

(51) Int. Cl. C02F 11/121; B03B 5/26; B09C 1/08; C02F 1/72; C05F 7/00

(52) U.S. Cl. CPC C02F 11/121; B03B 5/26; E02F 3/88; C02F 1/72; C05F 7/00; B09C 1/08

(57) ABSTRACT

A method and system of treating wetland areas includes collecting a slurry that includes sand/large particulates, water, and fines. The sand/large particulates are separated from the water and fines of the slurry. The sand/large particulates is preferably returned to a waterway or beach reclamation project. The water and fines are directed for application to wetland areas.

The application claims the priority benefit of U.S. provisional application Ser. No. 62/671,656, filed May 15, 2018.

### BACKGROUND

This invention relates to a separator system and particularly a system or assembly designed to take direct dredge flow or re-hydrated confined disposal facility material and separate large particulate material such as sand from the discharge. The invention also permits the remaining flow that is substantially free of the large particulate material to be directly applied to sensitive ecosystems or environmental regions such as wetlands without damaging the vegetative growth.

Waterways of various types and sizes continually fill with sediment and over time become less navigable. As a result, it is common to dredge the sediment from the waterway. Typically, the dredge material is stored in a confined disposal facility (CDF). It would be substantially less expensive to immediately separate large particulate material (e.g. large particulate sand) from the dredge material to eliminate the need for the CDF. Thus, taking direct dredge flow from a hydraulic dredger or treating a confined disposal facility by re-hydrating the CDF material and thereafter separating the large particulate material or sand from the discharge, would result in substantial improvements in efficiencies and total costs.

A need exists for an improved arrangement that provides at least one or more of the above-described features, as well as still other features and benefits.

### SUMMARY

A method of and a separator system is provided that separates particulate material such as sand from a dredge flow or re-hydrated CDF material.

The method of treating wetland areas includes the steps collecting a slurry that includes sand/large particulates, water, and fines; separating (i) the sand/large particulates from (ii) the water and fines of the slurry; returning the (i) sand/large particulates to a waterway; and applying the (ii) the water and fines to the wetland areas.

The method includes slowing a flow rate of the slurry to less than about five ft/sec to separate the sand/large particulates from the fines.

The flow rate slowing step preferably reduces the flow rate to about two to five ft/sec.

The separating step includes introducing the slurry that includes (i) the sand/large particulates and (ii) the water and fines into a sluice having a rectangular cross-section.

The separating step includes directing the slurry of (i) the sand/large particulates and (ii) the water and fines from an inlet of the sluice toward an outlet of the sluice, and passing the slurry over multiple, spaced collectors located in the sluice between the inlet and outlet thereof, each collector including (a) an upstream, upwardly ramped surface, (b) a more steeply angled downstream, downwardly ramped surface, and (c) an opening located between the ramped surfaces that receives the sand/large particulate portion of the slurry and the fines portion of the slurry proceeds toward the outlet of the sluice.

The method includes providing multiple discharge tubes beneath each collector and receiving the sand/large particulate portion of the slurry therefrom.

The method includes directing the sand/large particulate slurry from the discharge tubes onto a material conveyor.

The method further includes injecting an oxidizer into the sand/large particulate portion of the slurry.

The method further includes injecting an oxidizer into the sand/large particulate portion of the slurry.

The method further includes receiving the slurry that includes (i) the sand/large particulates and (ii) the water and fines directly from a hydraulic dredger.

The method wherein the slurry collecting step includes introducing water into a confined disposal facility that stores a partially dewatered combination of sand/large particulate and fines whereby the water introduction facilitates removal of the slurry to the sluice.

A system or apparatus of the present disclosure that separates sand/large particulates from fines contained in a slurry so that the fines can be deposited directly on vegetation in associated wetland areas includes a sluice having an inlet and an outlet spaced therefrom; at least first and second drop tubes communicating with a bottom portion of the sluice and located at axially spaced locations along the sluice between the inlet and outlet that receive the sand/large particulate portion of the slurry; and the sluice directing a remaining portion of the slurry containing water and fines to the outlet for application to vegetation in the associated wetland areas.

The inlet, outlet, and/or sluice are dimensioned to reduce a flow rate of the slurry to less than about five ft/sec., and more preferably between about two to about five ft/sec., to separate the sand/large particulates from the fines.

The sluice in one embodiment preferably has a rectangular cross-section.

In one version of the present disclosure the sluice includes multiple, spaced collectors between the inlet and outlet ends thereof, each collector including (a) an upstream, upwardly ramped surface, (b) a more steeply angled downstream, downwardly ramped surface, and (c) an opening located between the ramped surfaces that receives the sand/large particulate portion of the slurry and the fines portion of the slurry proceeds toward the outlet end of the sluice.

Each collector preferably includes multiple discharge tubes beneath the collector that receive the sand/large particulate portion of the slurry therefrom.

A material conveyor may be included that receives the sand/large particulate slurry from the discharge tubes.

An oxidizer may be incorporated into the apparatus/system that communicates with the sand/large particulate portion of the slurry.

Including a hydraulic dredger communicates the slurry that includes (i) the sand/large particulates and (ii) the water and fines directly to the sluice.

Alternatively, a confined disposal facility that stores a partially dewatered combination of sand/large particulate and fines, communicates with the sluice whereby water is capable of being added to the stored slurry to facilitate removal of the slurry to the sluice.

The method and system advantageously allow remaining effluent flow that carries fines to be used directly on select eco-systems such as wetlands, reclamation sites, etc.

Another benefit of the method and system resides in the elimination of a confined disposal facility (CDF), and particularly the cost of creating and maintaining a CDF.

Yet another advantage is associated with using the method and system of the present disclosure in conjunction with existing CDFs.

Benefits and advantages of the present disclosure will become more apparent from reading and understanding the following detailed description.

### BRIEF DESCRIPTION OF THE DRAWINGS

FIG. 1 is a perspective view of a separator system having a tubular passage that receives, for example, conditioned dredge flow or dredge flow directly from a hydraulic dredger (not shown).

FIG. 2 is a cross-sectional, perspective view of the system of FIG. 1.

FIG. 3 is an enlarged perspective view of and upstream end of one of the drop tubes.

FIG. 4 is a perspective view of a rectangular sluice modification of the system shown in FIG. 1 in order to handle extremely large quantities of dredge material.

FIG. 5 is a longitudinal cross-sectional view of the rectangular sluice and drop tube arrangement of FIG. 4.

FIG. 6 is a perspective view of a set of four drop tubes that extend laterally across the rectangular sluice of FIG. 4.

FIG. 7 is an elevational view of the set of four drop tubes extending laterally across the rectangular sluice of FIG. 6.

FIG. 8 is an enlarged, elevational view of one of the drop tubes.

FIG. 9 is an enlarged, cross-sectional view of the drop tube of FIG. 8.

FIG. 10 is an elevational view of a modified system that removes the ramps used in the prior embodiments.

FIG. 11 is a top plan view of the system of FIG. 10.

FIG. 12 is a longitudinal cross-sectional view of the system of FIG. 10.

FIG. 13 is a perspective view of a sluice arrangement that employs a reduced number of drop tubes.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.). The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments. The applicant commonly owns U.S. Pat. No. 7,975,850.

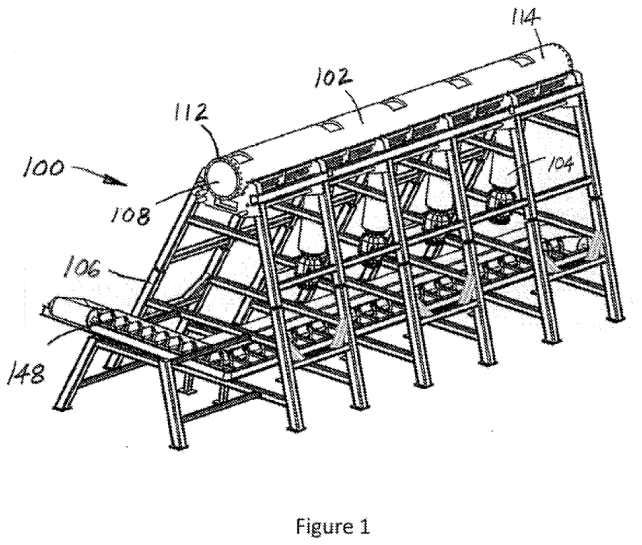

Turning initially to FIGS. 1-3, there is shown a separator system 100 designed to take direct dredge flow (e.g. from a hydraulic dredger) or re-hydrated confined disposal facility (CDF) material and separate large particulate material, such as sand, from the discharge. The sizing of the system 100 requires a main fluid passage 102 such as a pipe that communicates directly with the hydraulic dredger (not shown) or CDF to reduce the flow rate of the slurry (where the slurry generally includes sand/large particulate materials, fines, and water), for example to a velocity less than 5.0 (five) feet per second (ft/sec), and more preferably ranging from about 1.0 (one) to 5.0 (five) feet per second (ft/sec), to provide advantageous removal of most sand fractions. A slower velocity in the system 100 will capture finer sands. The system 100 can be matched to a specific flow and percentage of solids by changing dimensions in the system, for example, the diameter of the main fluid passage 102, increasing the length of the main fluid passage, and/or adjusting the number of drop tubes 104. The system 100 is designed to be operated in remote areas, i.e., where grid connections or power sources (not shown) may be limited, by using alternative power sources such as solar power and/or wind power and/or still other off-grid power sources. The system 100 includes a sturdy frame 106 such as a heavy steel, rectangular tubing, welded frame 106. Preferably the frame 106 is a modular construction allowing for ease of transport with minimal assembly required at a desired site.

Flow from the hydraulic dredger reaches or is introduced to an inlet or inlet end 108 of the main fluid passage 102. As the flow of the combined slurry (e.g., large particulates/sand/fines/water) proceeds downstream from the inlet or inlet end 108 of the main fluid passage 102, the flow proceeds over openings 110 extending through a wall 112 of the main fluid passage. Typically the openings 110 are located in a lower region of the passage. One or more individual sets of drop tubes 104 are longitudinally spaced along the length of the main fluid passage 102. Each drop tube 104 communicates with or forms the opening 110 that extends radially through the wall 112 of the main fluid passage 102. Each drop tube 104 is preferably positioned along the underside of the main fluid passage 102. In this manner, gravity is advantageously used to direct and encourage at least a portion of the flow proceeding longitudinally through the main passage 102 from the inlet 108 into a drop tube 104. As a result of the flow velocity through the main fluid passage 102 being reduced, a portion of the fluid (i.e., water) falls into a respective opening in a drop tube (along with the heaview particulate material carried by the slurry flow (large particulate material such as sand) as the flow proceeds toward a downstream end or outlet 114 of the main fluid passage 102. The water carries particulate material or sediment, that includes sand, organics, etc., and the reduction in the flow velocity allows the heavier particulate matter sufficient time to fall downwardly and pass into respective openings 110 of the drop tubes 104. Each drop tube 104 is preferably a hollow structure such as a cylindrically shaped structure that communicates with the main fluid passage 102 through the opening 110 at the first or upper end 120, through a central, dewatering portion 122, and communicates with an outlet 124 at a lower end of the individual drop tube. Preferably located at the outlet 124 of each drop tube 104 is a valve 126 such as an air operated pinch valve. When closed, the particulate material is stored within the drop tube 104 in a column. As the particulate material or sand collects in the individual drop tube 104, the weight of the heavier particulate material/sand displaces the water in the drop tube. Thus dewatering of the particulate material occurs so that when the particulate material is released upon opening of the pinch valve 126, the sand is substantially dewatered as it exits through outlet end 124 of the drop tube 104. The pinch valve 126 controls the discharge amount and weight of the particulate material released from an individual drop tube 104. Specifically, the pinch valve 126 is preferably controlled by a proportional valve, or still another conventional arrangement that controls the discharge amount and weight of the particulate material released from an individual drop tube 104.

A water/oxidizer inject 130 is advantageously provided at the upstream end of the drop tube 104 for upwelling flow. The water/oxidizer inject structure 130 can be used to inject water to keep the sand clean or to introduce an oxidizer or other treatment material (e.g., chlorinator) that can treat any contaminant found in the particulate material or in the water.

A load cell 140 (FIG. 3) is preferably located adjacent the upstream end of the drop tube 104 and sends a signal to a controller C. The load cell 140 is preferably located at the upstream end of each drop tube 104 and in one arrangement includes first and second rigid members such as plates 142, 144 joined by an expansion joint 146 and one or more load cells 140. For example, three load cells may be arranged about the perimeter of the expansion joint 146 to monitor the axial spacing between the plates 142, 144. When the axial spacing reaches a predetermined dimension, the load cell 140 sends a signal to the controller C and the controller, in turn, opens the pinch valve 126 of an individual drop tube 104 to allow the dewatered sediment/particulate material to exit the outlet end 124 of the drop tube 104. Once the sediment/particulate material has exited the drop tube through the valve, the valve closes and a new collection of sediment/particulate material is temporarily stored in the drop tube 104.

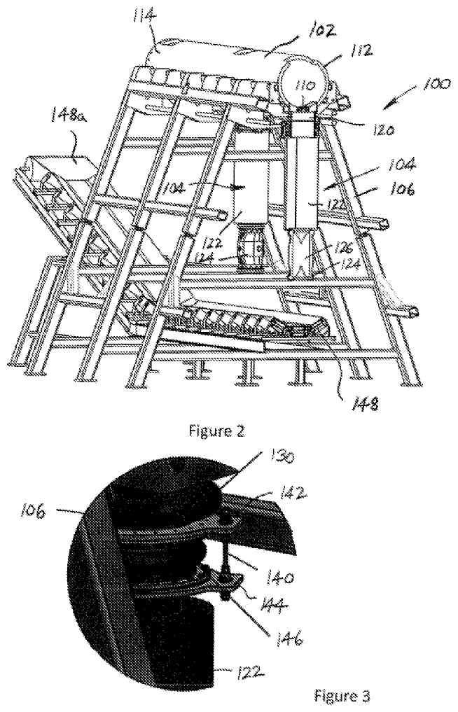

The dewatered sediment/particulate material falls from the individual outlet ends 124 of the drop tubes 104 onto a conveyor 148, such as a heavy-duty material conveyor that discharges to a desired site, For example as illustrated in FIG. 2, the conveyor 148 may also include an upwardly inclined portion 148a to allow for further gravity dewatering of the sediment/particulate material. The remaining sediment or particulate material can be passed through one or more screens or sieves (not shown) to further control the ultimate end use of the material, i.e., segregate the particulate material into different types of material where each segregated portion is substantially uniform.

The outlet end 110 of the main flow passage 102 carries the remaining effluent, i.e., water with fine particulate matter, to a downstream location. In association with river or beach reclamation, the larger particulate material (sand) is separated from the dredge flow or re-hydrated CDF and introduced to the beach. The flow of the effluent from the outlet end 110 of the main flow passage 102, on the other hand, can then be directly introduced into wetlands or other reclamation sites-particularly those with vegetation. In the past, this was not possible because the larger particular material associated with the dredge flow or re-hydrated CDF adversely covered the vegetation and would “bury” the vegetation (adversely impact the viability of the vegetation) as the particulate material further separated from water of the slurry. However, the slurry that carries the fines from which the large particulate materials/sand has been removed can be advantageously applied to wetlands.

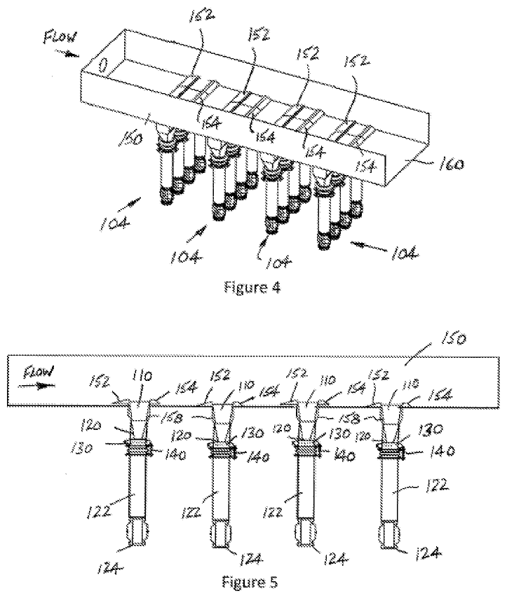

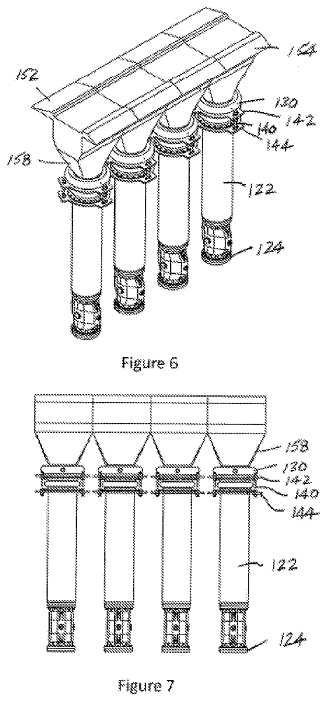

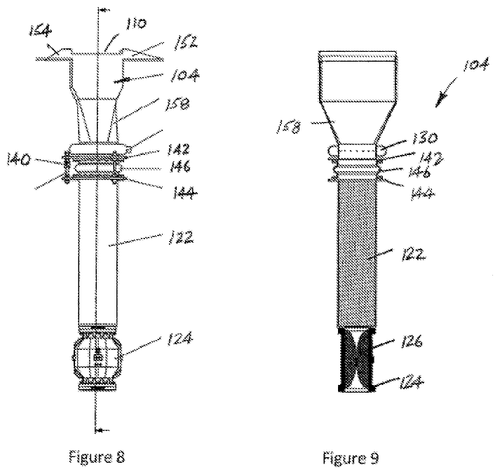

FIGS. 4-9 illustrate one modification to the structure of FIGS. 1-3. For ease of illustration and understanding, like reference numerals will refer to like components and new components or modifications will be identified by new reference numerals. Particularly, the main flow passage 102 is substituted with a rectangular, cross-sectional passage or sluice 150. The rectangular sluice 150 can be used to handle extremely large quantities of dredged material and likewise can be used to include multiple drop tubes at each longitudinal location, as well as larger drop tubes to handle the increased flow. The sixteen drop tubes 102 shown in the modified system of FIGS. 4-9 are arranged in groups or sets of four drop tubes at each longitudinal location where the groups are preferably equally-spaced in the longitudinal direction, and likewise preferably equally-spaced in the lateral direction. One skilled in the art will appreciate, however, that the spacing both longitudinally and laterally may be altered, or the number of drop tubes 102 in each group may be the same or different from one another, and likewise may be greater than or less than four in each group. An opening to the upper end of each drop tube 102 is disposed at a grate or opening in the sluice, and in some instances the opening is located between a gradual, upstream facing sloped surface or ramp 152 and a steeper, less gradual, downstream facing sloped surface or ramp 154. In addition, a grate 156 may overlie the openings to limit the size of the particulate material that passes therethrough. Further, a transition member 158 is interposed between the lower wall or bottom surface 160 of the sluice 150 and the opening at the upper end of each drop tube. The transition member 158 preferably tapers or transitions from a square or rectangular conformation to a cylindrical conformation and thereby facilitates movement of the particulate material into the drop tube 104. In a manner similar to the previously described embodiment, located upstream of the load cell assembly 140 is a water/oxidizer inject 130 for upwelling flow. The water/oxidizer inject structure 130 can be used to inject water to keep the sand clean or to introduce an oxidizer or other material that can treat contaminant found in the water and/or particulate material.

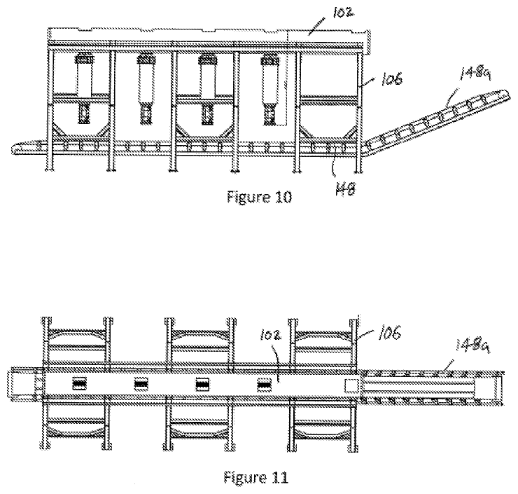

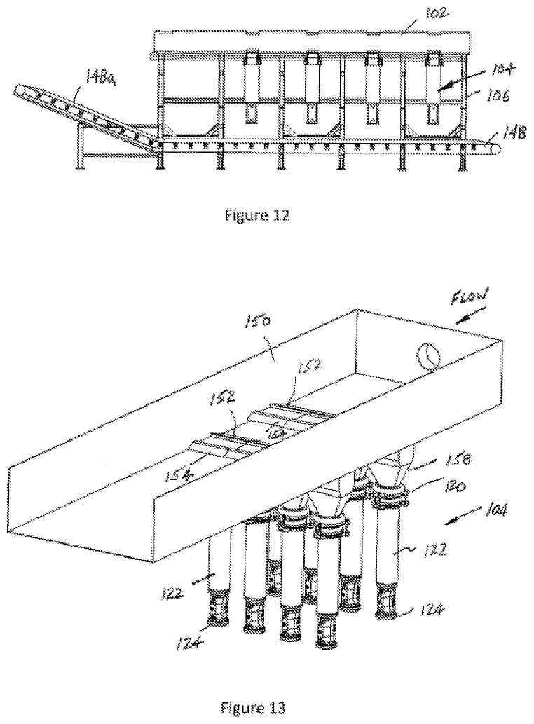

FIGS. 10-12 illustrate further modifications, for example, in which the ramps are removed within the main flow passage 102 or sluice 150 and around the openings 110 to the individual drop tubes 104. Instead, the opening 110 leads through the base wall of the passage/sluice and communicates directly with the upstream end 120 of each drop tube 104. If desired, a grate 156 can also be removed that is used to cover the entrance to the upstream end of the individual drop tubes 104.

FIG. 13 is substantially identical to the embodiment of FIGS. 4-9. It is included to illustrate that a greater or lesser number of drop tubes 104 can be incorporated into the system. Here, eight total drop tubes 104 are provided, and can be divided into two groups of four drop tubes at longitudinally spaced locations along the sluice box 150.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

1. A method of treating wetland areas comprising the steps of:
collecting a slurry that includes sand/large particulates, water, and fines;
separating (i) the sand/large particulates from (ii) the water and fines of the slurry;
returning the (i) sand/large particulates to a desired site; and
applying the (ii) the water and fines to the wetland areas.

2. The method of claim 1 wherein the separating step includes controlling the flow rate of the slurry from more than 1 ft/sec to five ft/sec allows the separation of the sand/large particulates from the fines.

3. The method of claim 2 wherein the flow rate slowing step reduces the flow rate to about one to five ft/sec.

4. The method of claim 1 wherein the separating step includes introducing the slurry that includes (i) the sand/large particulates and (ii) the water and fines into a sluice having a round or rectangular cross-section.

5. The method of claim 1 wherein the separating step includes directing the slurry of (i) the sand/large particulates and (ii) the water and fines from an inlet end of the sluice toward an outlet end of the sluice, and passing the slurry over multiple, spaced vertical collectors located in the sluice between the inlet and outlet ends thereof, each collector including (a) an upstream, upwardly ramped surface, (b) a more steeply angled downstream, downwardly ramped surface, and (c) an opening located between the ramped surfaces that receives the sand/large particulate portion of the slurry and the fines portion of the slurry proceeds toward the outlet end of the sluice.

6. The method of claim 5 wherein each collector includes multiple discharge tubes beneath the collector that receive the sand/large particulate portion of the slurry therefrom.

7. The method of claim 6 wherein the sand/large particulate slurry is directed from the discharge tubes onto a material conveyor.

8. The method of claim 6 further comprising injecting an oxidizer into the sand/large particulate portion of the slurry.

9. The method of claim 1 wherein the slurry collecting step includes receiving the slurry that includes (i) the sand/large particulates and (ii) the water and fines directly from a hydraulic dredger.

10. The method of claim 1 wherein the slurry collecting step includes introducing water into a confined disposal facility that stores a partially dewatered combination of sand/large particulate and fines whereby the water introduction facilitates removal of the slurry to the sluice.

11. An apparatus that separates sand/large particulates from fines contained in a slurry so that the fines can be deposited directly on vegetation in associated wetland areas, the apparatus comprising:
a sluice having an inlet and an outlet spaced therefrom; and
at least first and second drop tubes communicating with a bottom portion of the sluice and located at axially spaced locations along the sluice between the inlet and outlet that receive the sand/large particulate portion of the slurry and
direct a remaining portion of the slurry containing water and fines for application to vegetation in the associated wetland areas.

12. The apparatus of claim 11 further wherein the inlet, outlet, and/or sluice are dimensioned to reduce a flow rate of the slurry to less than about five ft/sec to separate the sand/large particulates from the fines.

13. The apparatus of claim 12 wherein the inlet, outlet, and/or sluice are dimensioned to reduce the flow rate to about one to five ft/sec.

14. (canceled)

15. The apparatus of claim 11 wherein the sluice includes multiple, spaced collectors between the inlet and outlet ends thereof, each collector including (a) an upstream, upwardly ramped surface, (b) a more steeply angled downstream, downwardly ramped surface, and (c) an opening located between the ramped surfaces that receives the sand/large particulate portion of the slurry and the fines portion of the slurry proceeds toward the outlet end of the sluice.

16. The apparatus of claim 15 wherein each collector includes multiple discharge tubes beneath the collector that receive the sand/large particulate portion of the slurry therefrom.

17. The apparatus of claim 16 further comprising a material conveyor that receives the sand/large particulate slurry from the discharge tubes.

18. The apparatus of claim 16 further comprising an oxidizer that communicates with the sand/large particulate portion of the slurry.

19. The apparatus of claim 11 further comprising a hydraulic dredger that communicates the slurry that includes (i) the sand/large particulates and (ii) the water and fines directly to the sluice.

20. The apparatus of claim 11 further comprising a confined disposal facility that stores a partially dewatered combination of sand/large particulate and fines and communicates with the sluice, whereby water is capable of being added to the stored slurry to facilitate removal of the slurry to the sluice.

21. The apparatus of claim 20 wherein each collector includes multiple discharge tubes beneath the collector that receives the sand/large particulate portion of the slurry, a pinch valve at a discharge end of each of the multiple discharge tubes that controls discharge of sand from the discharge tube, and a loadcell operatively associated with each pinch valve to maintain a set weight of the tube such that as sand fills the discharge tube, existing water is forced up and out of the tube by the weight of the sand and thereby dewaters the sand.
